(19) United States
(12) Patent Application Publication
(10) Pub. No.: US 2025/0363597 A1
(43) Pub. Date: Nov. 27, 2025

(54) IMAGE PROCESSING METHOD AND APPARATUS

(71) Applicant: Lenovo (Beijing) Limited, Beijing (CN)

(72) Inventors: Chen LIN, Beijing (CN); Shichang ZHAO, Beijing (CN)

(21) Appl. No.: 19/217,438

(22) Filed: May 23, 2025

(30) Foreign Application Priority Data
May 27, 2024 (CN) 202410666706.5

(51) Int. Cl. G06T 5/50; G06T 5/20; G06T 5/60; G06T 5/77; G06T 7/194; G06T 11/60

(52) U.S. Cl. CPC G06T 5/50; G06T 5/20; G06T 5/60; G06T 5/77; G06T 7/194; G06T 11/60; G06T 2207/20084; G06T 2207/20221

(57) ABSTRACT

An image processing method includes obtaining a first mask and a second mask, wherein the first mask represents an occupied area of a first object, and the second mask represents an occupied area of a second object, generating a third mask according to the first mask, the second mask, and a source image, wherein the third mask is used to indicate the occupied area of the second object in the source image, and the source image includes the first object, determining a foreground image according to the first mask, the second mask, and the third mask, wherein the foreground image includes the second object, removing the first object from the source image to determine a background image, and fusing the foreground image and the background image to obtain a target image that includes the second object but excludes the first object.

### CROSS-REFERENCE TO RELATED APPLICATION

The present disclosure claims priority to Chinese Patent Application No. 202410666706.5, filed on May 27, 2024, the entire content of which is incorporated herein by reference.

### TECHNICAL FIELD

The present disclosure is related to the image processing technology field and, more particularly, to an image processing method and an image processing apparatus.

### BACKGROUND

With the development of artificial intelligence technology, image conversion technology based on artificial intelligence has been widely used. The image conversion technology is also referred to as image-to-image (I2I) conversion, which converts an input image (i.e., source image) into another image (i.e., target image). The technology is used in a variety of application scenarios such as image enhancement, style transfer, and image editing. The problem of the current image conversion technology is that the shape of the area occupied by a second object in a converted image cannot be controlled, making it difficult to meet application requirements in specific scenarios.

### SUMMARY

An aspect of the present disclosure provides an image processing method. The method includes obtaining a first mask and a second mask, wherein the first mask represents an occupied area of a first object, and the second mask represents an occupied area of a second object, generating a third mask according to the first mask, the second mask, and a source image, wherein the third mask is used to indicate the occupied area of the second object in the source image, and the source image includes the first object, determining a foreground image according to the first mask, the second mask, and the third mask, wherein the foreground image includes the second object, removing the first object from the source image to determine a background image, and fusing the foreground image and the background image to obtain a target image that includes the second object but excludes the first object.

An aspect of the present disclosure provides an image processing apparatus, including an acquisition unit, a generation unit, a determination unit, a removal unit, and a fusion unit. The acquisition unit is configured to obtain a first mask and a second mask, wherein the first mask represents an occupied area of a first object, and the second mask represents an occupied area of a second object. The generation unit is configured to generate a third mask according to the first mask, the second mask, and a source image, wherein the third mask is used to indicate the occupied area of the second object in the source image, and the source image includes the first object. The determination unit is configured to determine a foreground image according to the first mask, the second mask, and the third mask, wherein the foreground image includes the second object. The removal unit is configured to remove the first object from the source image to determine a background image. The fusion unit is configured to fuse the foreground image and the background image to obtain a target image that includes the second object but excludes the first object.

An aspect of the present disclosure provides an electronic device, including one or more processors and one or more memories. The one or more memories store computer commands that, when executed by the one or more processors, causes the one or more processors to obtain a first mask and a second mask, wherein the first mask represents an occupied area of a first object, and the second mask represents an occupied area of a second object, generate a third mask according to the first mask, the second mask, and a source image, wherein the third mask is used to indicate the occupied area of the second object in the source image, and the source image includes the first object, determine a foreground image according to the first mask, the second mask, and the third mask, wherein the foreground image includes the second object, remove the first object from the source image to determine a background image, and fuse the foreground image and the background image to obtain a target image that includes the second object but excludes the first object.

### BRIEF DESCRIPTION OF THE DRAWINGS

FIG. 1 illustrates a schematic flowchart of an image processing method according to some embodiments of the present disclosure.

FIG. 2 illustrates a schematic diagram of an image and a mask according to some embodiments of the present disclosure.

FIG. 3 illustrates a schematic flowchart of obtaining a second mask according to some embodiments of the present disclosure.

FIG. 4 illustrates a schematic structural diagram of an image processing apparatus according to some embodiments of the present disclosure.

### DETAILED DESCRIPTION OF THE EMBODIMENTS

The technical solutions of the present disclosure are described in detail in connection with the accompanying drawings of embodiments of the present disclosure. The embodiments described are merely some embodiments of the present disclosure, not all embodiments. Based on embodiments of the present disclosure, all other embodiments obtained by those of ordinary skill in the art without creative efforts are within the scope of the present disclosure.

Image conversion is a common image processing technology. Through the image conversion technology, an electronic device can convert one instance of an image into another instance. The instance can be an object displayed in the image.

For example, the electronic device can obtain an image containing a sheep. The image can be processed through image conversion technology to replace the sheep in the image with a giraffe. In some other embodiments, the electronic device can obtain an image containing a wine bottle, and the wine bottle in the image can be replaced with a cup through image conversion technology.

The problem with the current image processing technology is that the shape of the instance cannot be controlled according to the user needs after the conversion. For example, in the above examples, the electronic device cannot replace the sheep in the image with a giraffe of a user-specified shape, nor replace the wine bottle with a cup of a user-specified shape.

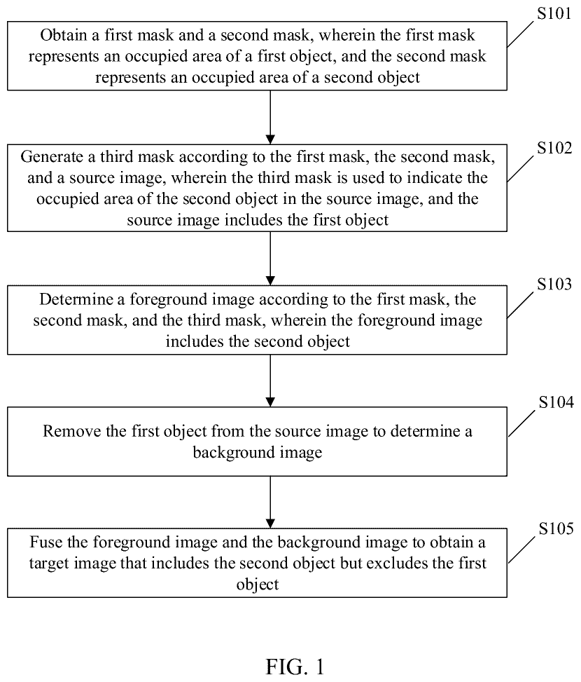

To address the above problem, embodiments of the present disclosure provide an image processing method. As shown in FIG. 1, the method includes the following steps.

At S101, a first mask and a second mask are obtained. The first mask represents an occupied area of a first object, and the second mask represents an occupied area of a second object.

An execution subject of the method of embodiments of the present disclosure can be any electronic device, e.g., a terminal electronic device (e.g., a personal computer) used by a user, or a server device communicatively connected to the terminal electronic device.

In the image processing method of embodiments of the present disclosure, one or more objects included in any source image that needs to be processed can be converted into other objects. For example, the electronic device can convert a sheep displayed in the source image into a giraffe.

The first mask can be obtained from the source image containing the first object. For example, the area occupied by the first object in the source image can be identified through image recognition technology. Then, the pixels within the occupied area of the first object can be set to white, and the pixels outside the occupied area can be set to black. The obtained black-and- white image representing the occupied area of the first object can be used as the first mask.

The source image can be specified by the user from a plurality of images or manually uploaded by the user.

In some embodiments, when the source image includes a plurality of objects, the user can input indication information to specify which objects in the source image need to be converted. The electronic device can then determine the first object from the plurality of objects in the source image according to the indication information to obtain the first mask.

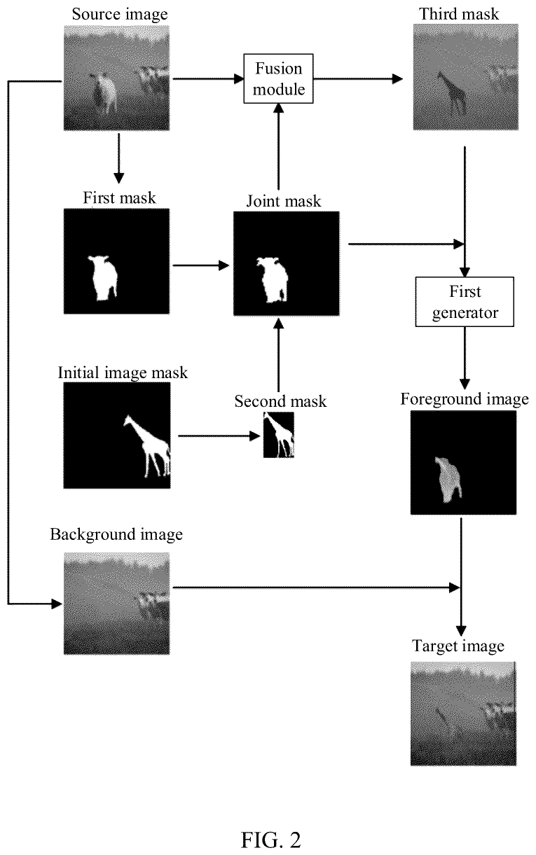

For example, as shown in FIG. 2, the source image is an image containing a plurality of pieces of sheep. The indication information input by the user specifies that the first sheep on the left side of the source image can be converted into a giraffe. Based on the indication information, the electronic device can determine that the first sheep on the left side of the source image is the first object, and identify the occupied area of the first object based on the image recognition technology to obtain the corresponding first mask.

The size of the first mask can be consistent with the size of the source image. For example, if the source image includes 360×360 pixels, the first mask can also include 360×360 pixels.

The second object can be the object into which the first object in the source image needs to be converted. In connection with the previous example, in the scenario of converting the first sheep on the left side of the source image into a giraffe, the giraffe can be the second object. The second mask can be used to represent the occupied area of the giraffe in a frame of image containing the giraffe.

At S102, a third mask is generated according to the first mask, the second mask, and the source image. The third mask is used to indicate the occupied area of the second object in the source image. The source image includes the first object.

In some embodiments, step S102 can include obtaining a joint mask formed by fusing the first mask and the second mask and generating the third mask according to the joint mask and the source image.

Fusing the first mask and the second mask to obtain the joint mask can include the following processes.

A minimum rectangular frame in the first mask that can exactly enclose the occupied area of the first object can be determined and marked as the first rectangular frame. A minimum rectangular frame in the second mask that can exactly enclose the occupied area of the second object can be determined and marked as the second rectangular frame.

A correspondence between the pixels in the first rectangular frame and the pixels at the same positions in the second rectangular frame can be determined. For example, the lower-left vertex of the first rectangular frame can be taken as the origin, and a pixel in the first rectangular frame can have a coordinate (x0, y0). The lower-left vertex of the second rectangular frame can be taken as the origin, and a pixel in the second rectangular frame can have a coordinate (x0, y0). Then, the pixel at (x0, y0) in the first rectangular frame can correspond to the pixel at (x0, y0) in the second rectangular frame.

For each black pixel in the first rectangular frame, if the corresponding pixel in the second rectangular frame is white, the black pixel in the first rectangular frame can be changed to white. This process can be repeated until every white pixel representing the occupied area of the second object in the second mask is mapped to the first mask. The image obtained after mapping can be equivalent to the joint mask by fusing the occupied area of the first object and the occupied area of the second object.

In the connection with the previous example, if the pixel at (x0, y0) in the first rectangular frame is black, and the pixel at (x0, y0) in the second rectangular frame is white, the pixel at (x0, y0) in the first rectangular frame can be changed to white. This process can be repeated until every white pixel representing the occupied area of the second object in the second mask is mapped to the first mask.

The size of the first mask can be consistent with the size of the joint mask. For example, if the first mask includes pixels of 360×360, the joint mask can also include pixels of 360×360.

When the third mask is generated, the electronic device can input the source image and the joint mask into a fusion module of an image processing model. The source image and the joint mask can be processed by the fusion module to obtain the third mask. The fusion module can include a preset soft gating parameter Wg (i.e., a first weight parameter), a feature mapping parameter Wf (i.e., a second weight parameter), a gating function, and an activation function.

The fusion module can be a convolutional neural network including four convolutional layers and a ReLU activation function.

Generating the third mask based on the fusion module can include processing the joint mask and the source image according to the first weight parameter of the target processing model to obtain the first image feature, processing the joint mask and the source image according to the second weight parameter of the target processing model to obtain the second image feature, and performing filtering on the second image feature according to the first image feature to obtain the third mask.

The process of obtaining the first image feature can be represented by formula (1).

$$SG ( w , h ) = \sum \sum Wg \cdot I \qquad ( 1 )$$

In formula (1), I denote the joint input data obtained by integrating the source image and the joint mask in the channel. SG denotes the first image feature obtained after processing the first weight parameter. The feature can be a matrix. SG denotes the numerical value of the element at position (w, h) in the first image feature.

Integrating the source image and the joint mask in the channel can include the following processes.

Three feature matrices can be used to represent the color source image. The three feature matrices can correspond to red, green, and blue channels, respectively. The size of each feature matrix can be consistent with the size of the source image. For example, if the source image includes pixels of 360×360, each feature matrix can include elements of 360×360. The elements can correspond to the pixels of the source image in a one-to-one correspondence. The value of each element can be equal to the value of the corresponding pixel of the source image in the corresponding color channel. For example, the value of the element corresponding to position (10, 20) in the feature matrix of the red channel can be the value of the pixel at (10, 20) in the source image in the red channel.

Similarly, a feature matrix can be used to represent the black-and-white joint mask.

Subsequently, the three feature matrices corresponding to the source image and the one feature matrix corresponding to the joint mask can be combined to form a dataset containing four feature matrices. The dataset can be the joint input data I obtained by integrating the source image and the joint mask in the channels. In other words, I can represent (Ir, Ig, Ib, I0). Ir, Ig, and Ib can be the three feature matrices corresponding to the red, green, and blue color channels of the source image, respectively, and I0 can be the feature matrix corresponding to the joint mask.

In formula (1), ΣΣ represents a convolution operation performed on the joint input data based on the first weight parameter. That is, pixel-by-pixel scanning can be performed on the joint input data. Each time, when a local area is scanned, element multiplication can be performed on the pixels in the local area and the first weight parameter. The result of the sum of all the multiplications can be used as value SG (w, h) of the corresponding position in the first image feature. The element multiplication can refer to multiplying the values corresponding to the pixels in the local area with the parameter values at the corresponding positions in the first weight parameter.

The process of obtaining the second image feature can be represented by formula (2).

$$F ( w , h ) = \sum \sum Wf \cdot I \qquad ( 2 )$$

where, F denotes the second image feature obtained after processing through the second weight parameter. The feature can be a matrix. F(w, h) denotes the value of the element at position (w, h) in the second image feature. The meanings of other symbols can be referred to above description.

The process of filtering the second image feature according to the first image feature can be represented by the formula (3).

$$O ( w , h ) = ϕ ( F ( w , h ) ) ⊙ σ ( SG ( w , h ) ) \qquad ( 3 )$$

where, O denotes the third mask after filtering, O(w, h) denotes the value of the pixel at position (w, h) in the third mask, ϕ denotes the activation function, σ denotes the gating function, and ⊙ denotes pixel-by-pixel product merging. The meanings of other symbols can be referred to the above description.

The meaning of formula (3) can include using the product of the result of processing SG(w, h) through the gating function and the result of processing F(w, h) through the activation function as O(w, h) of the third mask. The process can be repeated until the value of each pixel of the third mask is determined. The size of the third mask can be consistent with the size of the source image.

In the above formula, the expressions for the gating function and activation function can be found in relevant technical literature and are not limited here. The soft gating parameter Wg and the feature mapping parameter Wf can be determined when the image processing model is constructed, and the method for determining the soft gating parameter Wg and the feature mapping parameter Wf can be found in relevant technical literature.

In the connection with the above example, in the scenario of converting the first sheep on the left side of the source image into the giraffe, the first mask and the second mask can be fused to obtain the joint mask shown in FIG. 2. After the joint mask and the source image are input into the fusion module, the fusion module can fuse the joint mask and the source image to form the third mask shown in FIG. 2.

As shown in FIG. 2, the third mask includes, on one hand, a blank area formed by combining the occupied area of the first object and the occupied area of the second object, and on another hand, the image content of other parts of the source image outside the blank area.

At S103, a foreground image is determined based on the first mask, the second mask, and the third mask. The foreground image includes the second object.

Step S103 can include obtaining the joint mask formed by fusing the first mask and the second mask, integrating the third mask and the joint mask in the channel to obtain the joint input, and generating the foreground image according to the joint input.

In step S103, the electronic device can directly read the joint mask formed by fusion in step S102, then integrate the third mask and the joint mask in the channel to obtain the joint input. The method of integrating the third mask and the joint mask in the channel can be consistent with the method of integrating the source image and the joint mask in the channel, which is not repeated here.

After obtaining the joint input, the electronic device can provide the joint input to the first generator of the target processing model. The foreground image can be obtained by processing the joint input through the first generator. The process can be equivalent to using the first generator of the target processing model to process the first mask, the second mask, and the third mask to generate the foreground image.

The first generator can be a convolutional neural network including four convolutional layers and a ReLU activation function.

In addition to the fusion module, the target processing module can also include a first generator Gxy, a second generator Gyx, a first discriminator Dx, and a second discriminator Dy. The second generator Gyx, first discriminator Dx, and second discriminator Dy can be configured to adjust the parameters of the first generator. After the parameter adjustment (or training) process of the first generator is completed, the second generator Gyx, first discriminator Dx, and second discriminator Dy may no longer be used. That is, the first generator can independently generate the foreground image according to the joint input.

For example, the electronic device can integrate the joint mask and the third mask shown in FIG. 2 in the channel, and then provide the joint input obtained by the integration to the first generator to obtain the foreground image shown in FIG. 2 output by the first generator.

At S104, the first object in the source image is removed to determine the background image.

Step S104 can include cropping out a to-be-filled area indicated by the joint mask in the source image and filling the pixels within the to-be-filled area according to the image features outside the to-be-filled area in the source image to obtain the background image.

The to-be-filled area indicated by the joint mask can be an area in the source image corresponding to the white pixels of the joint mask. In this step, the lower-left vertex of the joint mask can be aligned with the lower-left vertex of the source image. Then, the target pixels in the source image can be determined, and the area formed by the target pixels can be determined as the to-be-filled area. Subsequently, the to-be-filled area can be cropped out from the source image. The target pixels can include pixels in the source image at the same positions as the white pixels in the joint mask. For example, if a pixel at (x1, y1) in the joint mask is white, the pixel at the same position (x1, y1) in the source image is a target pixel.

After cropping out the to-be-filled area, the pixels within the to-be-filled area can be filled according to the image features outside the to-be-filled area in the source image in the contextual residual aggregation (CRA) method. Thus, the pixels in the to-be-filled area can be similar to the pixels outside the to-be-filled area. For example, if the area outside the to-be-filled area displays green grass as the background, the to-be-filled area can also display green grass after filling.

When filling in the CRA method, contextual attention scores between the pixels inside and outside the to-be-filled region can be calculated. Then, based on the contextual attention scores, the values of the pixels outside the to-be-filled area can be calculated to obtain the values of the pixels inside the to-be-filled area to finish filling.

For the calculation method for contextual attention scores and the method of filling based on the contextual attention scores, reference can be made to relevant technical literature, which is not repeated here.)

The advantage of filling the to-be-filled area based on surrounding pixels after cropping out the to-be-filled area can include enhancing coherence between the pixels in the to-be-filled area and the original pixels that are not cropped, reducing the unnatural visual effect after cropping out the first object, and obtaining a more realistic background image. Thus, the real degree of the target image obtained by fusing the background image and the foreground image can be improved.

In connection with the above example, for the source image shown in FIG. 2, after the first object is removed according to step S104, the background image shown in FIG. 2 is obtained.

At S105, the foreground image and the background image are fused to obtain the target image, including the second object, not the first object.

In step S105, the foreground image and the background image can be directly stacked to form the target image. For the method for stacking the foreground image and the background image, reference can be made to the existing image-stacking technique, which is not repeated here.

In the connection with the above example, in step S105, the foreground image and background image shown in FIG. 2 can be stacked to form the target image shown in FIG. 2, including the second object giraffe not the first sheep (i.e., the first object) on the left side of the source image.

Embodiments of the present disclosure can include the following beneficial effects.

On one aspect, during the process of converting the first object of the source image into the second object, the source image can be processed by fusing the second mask representing the occupied area by the second object. Then, the shape of the second object in the target image obtained by conversion can be controlled by controlling the shape of the occupied area of the second object in the second mask. Thus, the shape of the second object in the output target image can be ensured to satisfy the needs of the user.

On another aspect, since the target image is obtained by fusing the foreground image and the background image, and the background image is obtained by cropping the source image, the target image and the source image can be controlled to have the same background in the processing method of embodiments of the present disclosure to retain the background of the source image in the target image as much as possible. Thus, the background of the target image can be ensured not to be affected by the second object for replacement.

On another aspect, when generating the foreground image, not only the second mask used to control the shape of the second object is considered, but also the first mask indicating the occupied area of the first object in the source image is considered. Thus, the occupied area of the first object indicated by the first mask can be used to control the position of the second object in the generated foreground image to ensure the position of the second object in the generated foreground image to be consistent with the position of the first object in the source image to further ensure the position of the second object in the target image to be consistent with the position of the first object in the source image. Thus, the problem of the second object appearing in another position to block the background content can be solved, and the visual effect of the target image can be improved.

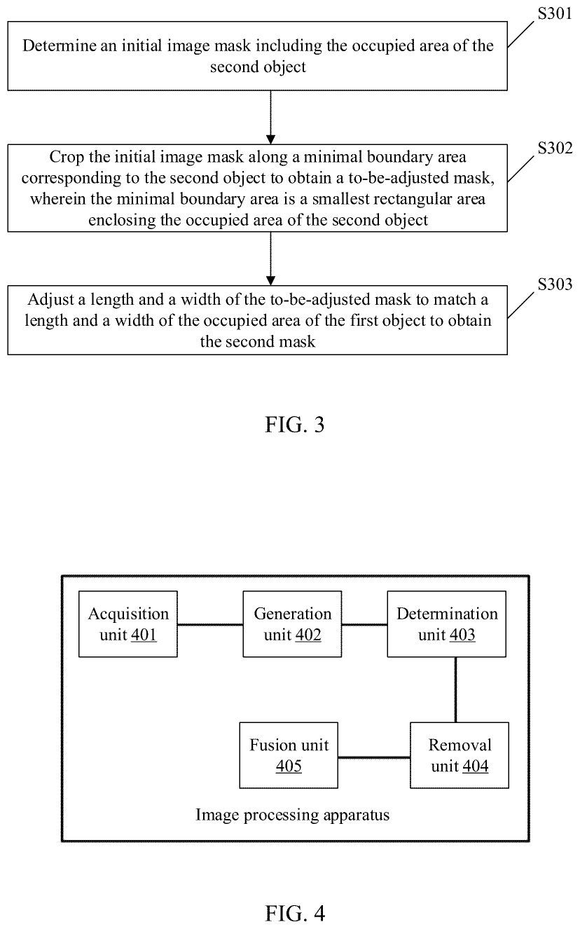

In some embodiments of the present disclosure, to avoid the mismatch between the size of the second object and the size of the source image to affect the visual effect of the target image after conversion, when the second mask is obtained, the size of the second mask can be appropriately adjusted. As shown in FIG. 3, the adjustment method can include the following steps.

At S301, an initial image mask including the occupied area of the second object is determined.

In step S301, the electronic device can respond to a selection command to select a candidate image from a plurality of candidate images, including the second object. The second object can have different occupied areas in different candidate images. Then, the initial image mask can be extracted from the selected candidate image.

The electronic device can obtain a keyword corresponding to the second object. Based on the keyword, several candidate images, including the second object can be found by searching the internet or a local gallery. The electronic device can display the candidate images to the user through the display for the user to select one candidate image from the candidate images.

For example, after the user inputs the keyword “Giraffe,” the electronic device can search according to the keyword to obtain a plurality of candidate images, including the giraffe.

The method of extracting the initial image mask from the candidate image can be consistent with the method of obtaining the first mask from the source image, which is not repeated here.

For example, the initial image mask shown in FIG. 2 can be obtained in step S301.

At S302, a to-be-adjusted mask is obtained by cropping the initial image mask along a minimal boundary area corresponding to the second object. The minimal boundary area is a minimal rectangular area enclosing the occupied area of the second object.

The minimal boundary area corresponding to the second object can be a rectangular area satisfying the following conditions.

The minimal boundary area corresponding to the second object can include the entire occupied area of the second object. In the initial image mask, all other rectangular areas including the entire occupied area of the second object can have areas bigger than the aera of the minimal boundary area.

In step S302, the electronic device can first determine the minimal bounding area in the initial image mask, then perform cropping on the initial image mask along the boundary of the minimal boundary area. After cropping, the parts outside the minimal boundary area can be discarded, only the part inside the minimal boundary area can be retained as the to-be-adjusted mask. For the method for determining the minimal boundary area, reference can be made to relevant technical materials, which are not repeated here.

At S303, the length and width of the to-be-adjusted mask are adjusted to match the length and width of the occupied area of the first object to obtain the second mask.

In step S303, the length and width of the occupied area of the first object can be the length and width of the minimal boundary area corresponding to the first object in the first mask.

For example, the second mask shown in FIG. 2 can be obtained through step S303.

Embodiments of the present disclosure can have the following beneficial effects.

By adjusting the second mask to be consistent with the length and width of the occupied area of the first object, the length and width of the occupied area of the second object in the target image obtained by conversion can be controlled through the second mask. Thus, the second object in the target image can have a consistent size as the first object in the source image to ensure that the size of the second object matches the size of the background of the source image to have a better visual effect for the target image.

Based on the above, the foreground image can be generated by the first generator (Gxy) of the target processing model. Before generating the foreground image using the first generator, the parameters of the first generator can be adjusted (trained) according to the sample image. The process of adjusting the parameters of the first generator can include the following processes.

The first sample image and the first sample mask can be processed by using the first generator to obtain the first generation image and the first generation mask. The first sample image can include the first object. The first sample mask can represent the occupied area of the first object in the first sample image. The first generator can be configured to convert the first object of the input image into the second object.

The second sample image and the second sample mask can be processed by the second generator to obtain the second generation image and the second generation mask. The second sample image can include the second object. The second sample mask can represent the occupied area of the second object in the second sample image. The second generator can be configured to convert the second object of the input image into the first object.

A generator loss of the first generator can be determined according to the first generation image, the first generation mask, the second generation image, and the second generation mask.

The parameters of the first generator can be adjusted according to the generator loss of the first generator.

The first sample mask Mx can be extracted from the first sample image after obtaining the first sample image Ximg. The second sample mask My can be extracted from the second sample image Yimg after obtaining the second sample image. The extraction method can refer to the method of obtaining the first mask.

The first generation mask My′ can be used to represent the occupied area of the second object in the first generation image Yimg′. The second generated mask Mx′ can be used to represent the occupied area of the first object in the second generated image Ximg′.

The first generation image generated by the first generator can include the background of the first sample image, including the second object, not the first object. The second generation image generated by the second generator can include the background of the second sample image, including the first object, not the second object.

The first object included in the first sample image in the parameter adjustment process can be another first object having the same category as the first object of the source image. For example, the first object of the source image and the first object of the first sample image can be two different sheep displayed in different images. The second object included in the second sample image can be another second object having the category as the second object in the candidate image.

In addition to the fusion module, the target processing module can further include the first generator Gxy, the second generator Gyx, the first discriminator Dx, and the second discriminator Dy. The second generator Gyx, the first discriminator Dx, and the second discriminator Dy can be configured to adjust the parameters of the first generator. After the parameter adjustment process (or training process) of the first generator is finished, the second generator Gyx, the first discriminator Dx, and the second discriminator Dy may be no longer used. That is, the first generator can generate the foreground image independently according to the joint input.

The process of generating the first generation image and the first generation mask using the first generator can be represented by formula (4):

$$( {Yimg}^{′} , {My}^{′} ) = Gxy ( Ximg , Mx ) \qquad ( 4 )$$

The process of generating the second generated image and second generated mask using the second generator can be represented by the formula (5):

$$( {Ximg}^{′} , {Mx}^{′} ) = Gyx ( Yimg , My ) \qquad ( 5 )$$

In embodiments of the present disclosure, the generator loss can include a discriminator loss, a cycle-consistency loss, an identification loss, and a contextual loss. That is, when the generator loss is obtained, the discriminator loss, the cycle-consistency loss, the identification loss, and the contextual loss can be obtained first according to the first generation image, the first generation mask, the second generation image, and the second generation mask. Then, the generator loss can be obtained according to the discriminator loss, the cycle-consistency loss, the identification loss, and the contextual loss.

The discriminator loss (L_{LSGAN}) can be represented by the formula (6):

$${L}_{LSGAN} = {( Dx ( Ximg , Mx ) - 1 )}^{2} + {( Dx ( Gyx ( Yimg , My ) ) )}^{2} + {( Dy ( Yimg , My ) - 1 )}^{2} + {( Dx ( Gxy ( Ximg , Mx ) ) )}^{2} \qquad ( 6 )$$

The first discriminator can be configured to determine whether the first object in the input image is a real first object. The output result can be the probability that the first object in the input image is real. For example, Dx(Ximg, Mx) can represent the probability that the first object in the first sample image is real. Dx(Gyx (Yimg, My)) can represent the probability that the first object in the second generation image generated by the second generator is real.

Correspondingly, the second discriminator can be configured to determine whether the second object included in the input image is the real second object. The output result can be the probability that the second object included in the input image is the real second object.

The smaller the discriminator loss is, the stronger the recognition capability of the discriminator is.

The first object in the image can be the real first object. Thus, the first object in the image may not be the first object obtained by the conversion of the second generator but the original first object in the image. Correspondingly, if the first object in the image is the first image obtained by the conversion of the second generator, the first object may not be the real first object.

The second object in the image being the real second object can indicate that the second object in the image is not the second object obtained by the conversion of the second generator, but the original second object of the image. Correspondingly, if the second object in the image is the second object obtained by the conversion of the second generator, the second object may not be the real second object.

The cycle-consistency loss L_{c1} can be represented by the formula (7):

$${L}_{c 1} = {‖ ( Yimg , My ) - ( Gxy ( {Ximg}^{′} , {Mx}^{′} ) ⊙ {Mx}^{′} ) ‖}_{1} + {‖ ( Ximg , Mx ) - ( Gyx ( {Yimg}^{′} , {My}^{′} ) ⊙ {My}^{′} ) ‖}_{1} \qquad ( 7 )$$

where, the meaning of ⊙ is as described above, ∥ ∥ represents calculating the sum of the absolute values of all elements in the matrix. For example, ∥P∥₁ represents the sum of the absolute values of all elements in matrix P.

(Yimg, My) represents that the parts other than the occupied area of the second object in the second sample image are filtered out using the second sample mask, and only the pixels in the occupied area of the second object are retained. Gxy(Ximg′, Mx′) ⊙ Mx′ represents that the parts other than the occupied area of the second object are filtered out in the image output by the Gyx using the second generation mask, and only the pixels in the occupied area of the second object can be retained.

The smaller the cycle-consistency loss is, the more the background of the first sample image can be retained in the first generation image output by the first generator, and the more the background of the second sample image can be retained in the second generation image output by the second generator.

The identification loss L_{idt} can be represented by the formula 8:

$${L}_{idt} = {‖ Gxy ( Ximg , Mx ) - ( Yimg , My ) ‖}_{1} + {‖ Gyx ( Yimg , My ) - ( Ximg , Mx ) ‖}_{1} \qquad ( 8 )$$

The smaller the identification loss is, the more similar the second object in the first generation image is to the second object in the second sample image, and the more similar the first object in the second generation image is to the first object in the first sample image.

To make the generator focus more on conversion, the contextual loss L_{c2} can be introduced in embodiments of the present disclosure. The loss can be represented by formula (9):

$${L}_{c 2} = {‖ U ( Mx , My ) ⊙ ( Ximg - {Yimg}^{′} ) ‖}_{1} + {‖ U ( My , Mx ) ⊙ ( Yimg - {Ximg}^{′} ) ‖}_{1} \qquad ( 9 )$$

where, U(Mx, My) and U(My, Mx) represent masks obtained by fusing the first sample mask and the second sample mask. The fusion method can be consistent with the fusion method of fusing the first mask and the second mask to obtain the joint mask, which is not repeated here.

After the four losses are obtained, the generator loss L can be determined by formula (10):

$$L = {L}_{LSGAN} + {λ}_{c} {L}_{c 1} + {λ}_{idt} {L}_{idt} + {L}_{c 2} \qquad ( 10 )$$

where, λ_{c} and λ_{idt} are a predetermined cycle consistency weight and a predetermined identification weight, respectively.

After the generator loss is obtained, whether the generator loss meets the convergence condition can be determined. If the convergence condition is met, the parameter adjustment process for the first generator can be determined to be complete. If the convergence condition is not met, the parameters of the first generator, the second generator, the first discriminator, and the second discriminator can be adjusted according to the generator loss of the first generator. For the adjustment method, reference can be made to relevant technical literature, which is not be repeated here.

The convergence condition can include that the generator loss is smaller than or equal to the predetermined loss threshold.

For example, the above parameter adjustment process can be performed based on the following hyperparameter settings, λc=1.0, λ_{idt}=1.0, epoch=215, and batch_{size}=2. The parameter setting of an Adam (adaptive moment estimation) optimizer can be β₁=0.5, β₂=0.999, Learning rate lr=0.002, and Learning rate decay parameter lr-decay-epoch=35. Epoch represents the number of iterations in the parameter adjustment process. batchsize represents the number of samples used in one parameter adjustment.

After the parameter adjustment is performed according to the above hyperparameter setting, the quality metrics of the images generated by the first generator can be represented by Table 1 below. For comparison, InstaGAN in Table 1 represents the quality metrics of images generated by the InstaGAN model.

TABLE 1

| | FID | SSIM | PSNR | LPIPS |
|---|---|---|---|---|
| InstaGAN | 18.2 | 0.0697 | 9.07 | 0.7223 |
| First Generator | 19.1 | 0.07722 | 9.785 | 0.7423 |

FID represents Fréchet Inception Distance, SSIM represents Structural SIMilarity, LPIPS represents Learned Perceptual Image Patch Similarity, and PSNR represents Peak Signal-to-Noise Ratio.

The first generator obtained based on the hyperparameter setting and the parameter adjustment method above can generate an image with better quality metrics.

Embodiments of the present disclosure further provide an image processing apparatus. As shown in FIG. 4, the apparatus includes an acquisition unit 401, a generation unit 402, a determination unit 403, a removal unit 404, and a fusion unit 405.

The acquisition unit 401 can be configured to obtain the first mask and the second mask. The first mask can represent the occupied area of the first object. The second mask can represent the occupied area of the second object.

The generation unit 402 can be configured to generate the third mask according to the first mask, the second mask, and the source image. The third mask can be configured to indicate the occupied area of the second object in the source image. the source image can include the first object.

The determination unit 403 can be configured to determine the foreground image according to the first mask, the second mask, and the third mask. The foreground image can include the second object.

The removal unit 404 can be configured to remove the first object in the source image to determine the background image.

The fusion unit 405 can be configured to fuse the foreground image and the background image to obtain the target image including the second object, not the first object.

In some embodiments, when the third mask is generated according to the first mask, the second mask, and the source image, the generation unit 402 can be configured to obtain the joint mask formed fusing the first mask and the second mask, and generating the third mask according to the joint mask and the source image.

In some embodiments, the generation unit 402 can be configured to, when the third mask is generated according to the joint mask and the source image, process the joint mask and the source image according to the first weight parameter of the target processing model to obtain the first image feature, process the joint mask and the source image according to the second weight parameter of the target processing model to obtain the second image feature, and filter the second image feature according to the first image feature to obtain the third mask.

In some embodiments, when the foreground image is determined according to the first mask, the second mask, and the third mask, the determination unit 403 can be configured to process the first mask, the second mask, and the third mask using the first generator of the target processing model to obtain the foreground image.

The determination unit 403 can be configured to adjust the parameters of the first generator through the following processes.

The first sample image and the second sample image can be processed by using the first generator to obtain the first generation image and the first generation mask. The first sample image can include the first object. The first sample mask can represent the occupied area of the first object in the first sample image. The first generator can be configured to convert the first object of the input image into the second object.

The second sample image and the second sample mask can be processed by using the second generator to obtain the second generation image and the second generation mask. The second sample image can include a second object. The second sample mask can represent the occupied area of the second object in the second sample image. The second generator can be configured to convert the second object of the input image into the first object.

The generator loss of the first generator can be determined according to the first generation image, the first generation mask, the second generation image, and the second generation mask.

The parameters of the first generator can be adjusted according to the generator of the first generator.

In some embodiments, the generator loss can include the discriminator loss, the cycle consistency loss, the identification loss, and the contextual loss.

In some embodiments, the removal unit 404 can be configured to, when removing the first object in the source image to determine the background image, cropping the to-be-filled area indicated by the joint mask in the source image and filling the pixels in the to-be-filled area according to the image feature of the source image in the to-be-filled area to obtain the background image.

In some embodiments, when obtaining the second mask, the acquisition unit 401 can be configured to determine the initial image mask including the occupied area of the second object, cropping in the initial image mask along the minimal boundary area corresponding to the second object to obtain the to-be-adjusted mask, the minimal boundary area being the minimal rectangular area enclosing the occupied area of the second object, and adjusting the length and width of the to-be-adjusted mask to be consistent with the length and width of the occupied area of the first object.

In some embodiments, the acquisition unit 401 can be configured to, when determining the initial image mask including the occupied area of the second object, in response to the selection command, selecting one candidate image from the plurality of candidate images including the second object, the second object having different occupied areas in different candidate images, and extracting the initial image mask from the selected candidate image.

In some embodiments, the determination unit 403 can be configured to, when determining the foreground image according to the first mask, the second mask, and the third mask, obtain the joint mask by fusing the first mask and the second mask, integrating the third mask and the joint mask in the channel to obtain the joint input, and generating the foreground image according to the joint input.

For the operation principles of the image processing apparatus of embodiments of the present disclosure, reference can be made to the steps of the image processing method of embodiments of the present disclosure, which are not repeated here.

Embodiments of the present disclosure are described progressively. Each embodiment focuses on differences from other embodiments. Similar or identical parts between embodiments can be cross-referenced.

To facilitate description, when the above system or apparatus is described, the system or apparatus can be divided into modules or units according to the function for description. Of course, functions of the modules or units can be implemented in the same piece or a plurality of pieces of software or hardware.

Through the above description, those skilled in the art can understand that the present disclosure can be implemented by software with a necessary general hardware platform. Through this understanding, the essence or the part contributing to the relevant technology of the technical solution of the present disclosure can be embedded in the form of the software product. The computer software product can be stored in a storage medium, e.g., ROM/RAM, magnetic disks, and optical discs, and include several commands to cause the computer device (e.g., PC, server, or network device) to execute the methods described in embodiments or specific portions of embodiments of the present disclosure.

In the present specification, relational terms such as first, second, third, and fourth are merely used to distinguish one entity or operation from another entity or operation, without necessarily requiring or implying any actual such relationship or order between these entities or operations. Moreover, the terms “include,” “comprise,” or any other variations thereof are intended to cover non-exclusive inclusion, so that a process, method, article, or device that includes a series of elements includes not only those elements but also other elements not explicitly listed, or further includes elements inherent to such process, method, article, or device. Without further limitation, an element defined by the phrase “comprising a . . .” does not exclude the presence of additional identical elements in the process, method, article, or device that includes the element.

The above description are some embodiments of the present disclosure. For those of ordinary skill in the art, without departing from the principles of the present disclosure, several improvements and modifications can be made. These improvements and modifications should also be within the scope of the present disclosure.

What is claimed is:

1. An image processing method comprising:
obtaining a first mask and a second mask, wherein the first mask represents an occupied area of a first object, and the second mask represents an occupied area of a second object;
generating a third mask according to the first mask, the second mask, and a source image, wherein the third mask is used to indicate the occupied area of the second object in the source image, and the source image includes the first object;
determining a foreground image according to the first mask, the second mask, and the third mask, wherein the foreground image includes the second object;
removing the first object from the source image to determine a background image; and
fusing the foreground image and the background image to obtain a target image that includes the second object but excludes the first object.

2. The method according to claim 1, wherein generating the third mask according to the first mask, the second mask, and the source image includes:
obtaining a joint mask formed by fusing the first mask and the second mask; and
generating the third mask according to the joint mask and the source image.

3. The method according to claim 2, wherein generating the third mask according to the joint mask and the source image includes:
processing the joint mask and the source image according to a first weight parameter of a target processing model to obtain a first image feature;
processing the joint mask and the source image according to a second weight parameter of the target processing model to obtain a second image feature; and
filtering the second image feature according to the first image feature to obtain the third mask.

4. The method according to claim 1, wherein:
determining the foreground image according to the first mask, the second mask, and the third mask includes:
processing the first mask, the second mask, and the third mask using a first generator of a target processing model to obtain the foreground image;
adjusting parameters of the first generator includes:
processing a first sample image and a first sample mask using the first generator to obtain a first generation image and a first generation mask, wherein the first sample image includes the first object, the first sample mask represents an occupied area of the first object in the first sample image, and the first generator is configured to convert the first object in an input image into the second object;
processing a second sample image and a second sample mask using a second generator to obtain a second generation image and a second generation mask, wherein the second sample image includes the second object, the second sample mask represents an occupied area of the second object in the second sample image, and the second generator is configured to convert the second object in the input image into the first object;
determining a generator loss of the first generator according to the first generation image, the first generation mask, the second generation image, and the second generation mask; and
adjusting the parameters of the first generator according to the generator loss of the first generator.

5. The method according to claim 4, wherein the generator loss includes a discriminator loss, a cycle-consistency loss, an identification loss, and a contextual loss.

6. The method according to claim 1, wherein removing the first object from the source image to determine the background image includes:
cropping out a to-be-filled area indicated by the joint mask from the source image; and
filling pixels within the to-be-filled area according to an image feature outside the to-be-filled area in the source image to obtain the background image.

7. The method according to claim 1, wherein obtaining the second mask includes:
determining an initial image mask including the occupied area of the second object;
cropping the initial image mask along a minimal boundary area corresponding to the second object to obtain a to-be-adjusted mask, wherein the minimal boundary area is a smallest rectangular area enclosing the occupied area of the second object; and
adjusting a length and a width of the to-be-adjusted mask to match a length and a width of the occupied area of the first object to obtain the second mask.

8. The method according to claim 7, wherein determining the initial image mask including the occupied area of the second object includes:
selecting one candidate image from a plurality of candidate images including the second object in response to a selection command, wherein the second object has different occupied areas in different candidate images; and
extracting the initial image mask from the selected candidate image.

9. The method according to claim 1, wherein determining the foreground image according to the first mask, the second mask, and the third mask includes:
obtaining a joint mask formed by fusing the first mask and the second mask;
integrating the third mask and the joint mask in a channel to obtain a joint input; and
generating the foreground image according to the joint input.

10. An image processing apparatus comprising:
an acquisition unit configured to obtain a first mask and a second mask, wherein the first mask represents an occupied area of a first object, and the second mask represents an occupied area of a second object;
a generation unit configured to generate a third mask according to the first mask, the second mask, and a source image, wherein the third mask is used to indicate the occupied area of the second object in the source image, and the source image includes the first object;
a determination unit configured to determine a foreground image according to the first mask, the second mask, and the third mask, wherein the foreground image includes the second object;
a removal unit configured to remove the first object from the source image to determine a background image; and
a fusion unit configured to fuse the foreground image and the background image to obtain a target image that includes the second object but excludes the first object.

11. The method according to claim 10, wherein the generation unit is further configured to:
obtain a joint mask formed by fusing the first mask and the second mask; and
generate the third mask according to the joint mask and the source image.

12. An electronic device comprising:
one or more processors; and
one or more memories storing computer commands that, when executed by the one or more processors, cause the one or more processors to:
obtain a first mask and a second mask, wherein the first mask represents an occupied area of a first object, and the second mask represents an occupied area of a second object;
generate a third mask according to the first mask, the second mask, and a source image, wherein the third mask is used to indicate the occupied area of the second object in the source image, and the source image includes the first object;
determine a foreground image according to the first mask, the second mask, and the third mask, wherein the foreground image includes the second object;
remove the first object from the source image to determine a background image; and
fuse the foreground image and the background image to obtain a target image that includes the second object but excludes the first object.

13. The device according to claim 12, wherein the one or more processors are further configured to:
obtain a joint mask formed by fusing the first mask and the second mask; and
generate the third mask according to the joint mask and the source image.

14. The device according to claim 13, wherein the one or more processors are further configured to:
process the joint mask and the source image according to a first weight parameter of a target processing model to obtain a first image feature;
process the joint mask and the source image according to a second weight parameter of the target processing model to obtain a second image feature; and
filter the second image feature according to the first image feature to obtain the third mask.

15. The device according to claim 12, wherein the one or more processors are further configured to:
process the first mask, the second mask, and the third mask using a first generator of a target processing model to obtain the foreground image;
process a first sample image and a first sample mask using the first generator to obtain a first generation image and a first generation mask, wherein the first sample image includes the first object, the first sample mask represents an occupied area of the first object in the first sample image, and the first generator is configured to convert the first object in an input image into the second object;
process a second sample image and a second sample mask using a second generator to obtain a second generation image and a second generation mask, wherein the second sample image includes the second object, the second sample mask represents an occupied area of the second object in the second sample image, and the second generator is configured to convert the second object in the input image into the first object;
determine a generator loss of the first generator according to the first generation image, the first generation mask, the second generation image, and the second generation mask; and
adjust the parameters of the first generator according to the generator loss of the first generator.

16. The device according to claim 15, wherein the generator loss includes a discriminator loss, a cycle-consistency loss, an identification loss, and a contextual loss.

17. The device according to claim 12, wherein the one or more processors are further configured to:
crop out a to-be-filled area indicated by the joint mask from the source image; and
fill pixels within the to-be-filled area according to an image feature outside the to-be-filled area in the source image to obtain the background image.

18. The device according to claim 12, wherein the one or more processors are further configured to:
determine an initial image mask including the occupied area of the second object;
crop the initial image mask along a minimal boundary area corresponding to the second object to obtain a to-be-adjusted mask, wherein the minimal boundary area is a smallest rectangular area enclosing the occupied area of the second object; and
adjust a length and a width of the to-be-adjusted mask to match a length and a width of the occupied area of the first object to obtain the second mask.

19. The device according to claim 18, wherein the one or more processors are further configured to:
select one candidate image from a plurality of candidate images including the second object in response to a selection command, wherein the second object has different occupied areas in different candidate images; and
extract the initial image mask from the selected candidate image.

20. The device according to claim 12, wherein the one or more processors are further configured to:
obtain a joint mask formed by fusing the first mask and the second mask;
integrate the third mask and the joint mask in a channel to obtain a joint input; and
generate the foreground image according to the joint input.
